(19) United States
(12) Patent Application Publication
(10) Pub. No.: US 2010/0232154 A1
(43) Pub. Date: Sep. 16, 2010

(54) FLUORESCENT TUBE

(76) Inventor: Chung-Yu Chen, Taipei Hsien (TW)

Correspondence Address: THE WEINTRAUB GROUP, P.L.C., 28580 Orchard Lake Road, Suite 140, Farmington Hills, MI, 48334, US

(21) Appl. No.: 12/402,074

(22) Filed: Mar. 11, 2009

(51) Int. Cl. F21V 1/00

(52) U.S. Cl. 362/235

(57) ABSTRACT

A fluorescent tube has a seat, a circuit board, multiple light-emitting-diodes (LED), a lampshade and two electrical terminal. The seat has two ends and a mounting surface. The circuit board is mounted on the mounting surface and has top surface. The LED is mounted on the top surface of the circuit board. The lampshade is transparent and is mounted on the seat, covers the circuit board and has an inner surface and a lens. The inner surface is opposite to the mounting surface of the seat. The lens is formed on the inner surface and faces the LEDs to guide the light of the LEDs. The electrical terminals are respectively mounted on the ends of the seat. Because the fluorescent tube does not have any reflection board, the manufacturing time and cost of the fluorescent tube decrease.

### BACKGROUND OF THE INVENTION

1. Field of the Invention

The present invention relates to a fluorescent tube, especially to be the fluorescent tube having a lens guiding the light from light emitting diodes thereof.

2. Description of the Prior Arts

A fluorescent tube in accordance with the prior art is used to illumine an indoor environment and has a lamp holder, a circuit board and a lampshade. The circuit board is mounted on the lamp holder and has multiple light-emitting-diodes (LEDs). The lampshade is transparent, is mounted on the lamp holder and covers the circuit board. When the LEDs radiate the light, the light passes through the lampshade and illuminates the indoor room.

The aforementioned fluorescent tube has two methods to increase the illumination in the indoor room. One is adding the number of the LEDs. The other is that the fluorescent tube further has a reflection board to reflect and concentrate the light of the LED towards the illuminating direction.

However, the cost of the LEDs is high. In addition, the fabricating the reflection board to the fluorescent tube increases the designing and manufacturing time and cost, which lowers the production rate of the fluorescent tube. Therefore, the aforementioned methods are not economical.

To overcome the shortcomings, the present invention provides a fluorescent tube to mitigate or obviate the aforementioned problems.

### SUMMARY OF THE INVENTION

The main objective of the present invention is to provide a fluorescent tube that has a lens guiding the light from light emitting diodes thereof.

A fluorescent tube in accordance with the present invention has a seat, a circuit board, multiple light-emitting-diodes (LEDs), a lampshade and two electrical terminal. The seat has two ends and a mounting surface. The circuit board is mounted on the mounting surface and has top surface. The LED is mounted on the top surface of the circuit board. The lampshade is transparent and is mounted on the seat, covers the circuit board and has an inner surface and a lens. The inner surface is opposite to the mounting surface of the seat. The lens is formed on the inner surface and faces the LEDs to guide the light of the LEDs. The electrical terminals are respectively mounted on the ends of the seat. Because the fluorescent tube does not have any reflection board, the manufacturing time and cost of the fluorescent tube decrease.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a fluorescent tube in accordance with the present invention;

FIG. 2 is a side view of the fluorescent tube in FIG. 1 without the electrical terminals;

FIG. 3 is a perspective view of the fluorescent tube in FIG. 1; and

FIG. 4 is a perspective view of the fluorescent tube mounted on a lamp holder.

### DETAILED DESCRIPTION OF THE PREFERRED EMBODIMENTS

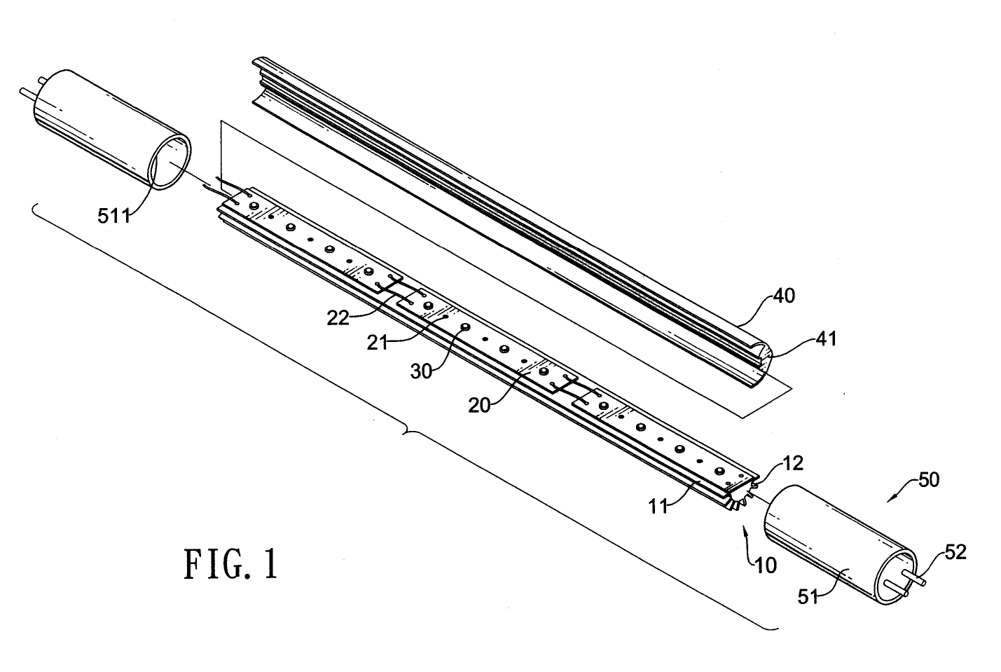

With reference to FIG. 1, a fluorescent tube in accordance with the present invention comprises a seat (10), at least one circuit board (20), at least one set of multiple light-emitting-diodes (LED) (30), a lampshade (40) and two electrical terminals (50).

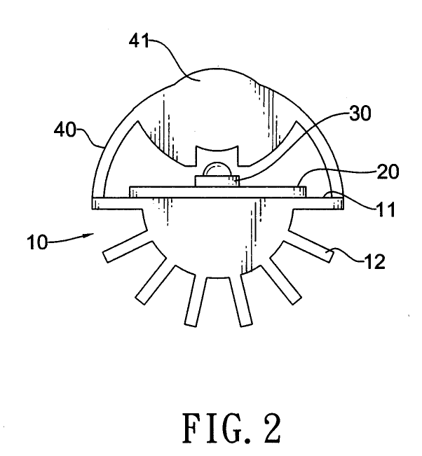

With further reference to FIG. 2, the seat (10) is semicylindrical, is a heat sink and has a top, a bottom, two ends, a mounting surface (11) and multiple fins (12). The bottom is curved. The mounting surface (11) is formed on the top of the seat (10). The fins (12) are formed on and protrude radially from the bottom of the seat (10) and dissipate heat from the LEDs (30).

The at least one circuit board (20) is mounted on the mounting surface (11) and each circuit board (20) has a top surface and multiple fastening elements (21). The fastening elements (21) may be screw mounting the circuit board on the mounting surface (11) of the seat (10). When multiple circuit boards (20) are implemented, adjacent circuit boards (20) are connected together through wires (22). In a preferred embodiment, three circuit boards (20) are implemented and are arranged in a line.

Each of the at least one set of the LEDs (30) is mounted on the top surface of one of the at least one circuit board (20) and the LEDs (30) of each set are located at intervals.

The lampshade (40) is transparent and semicylindrical and is mounted on the seat (10), covers the at least one circuit board (20) and has an inner surface and a lens (41). The inner surface is opposite to the mounting surface (11) of the seat (10). The lens (41) is elongated, is formed longitudinally on the inner surface and faces the LEDs (30) to refract and guide the light of the LEDs (30) into desired directions.

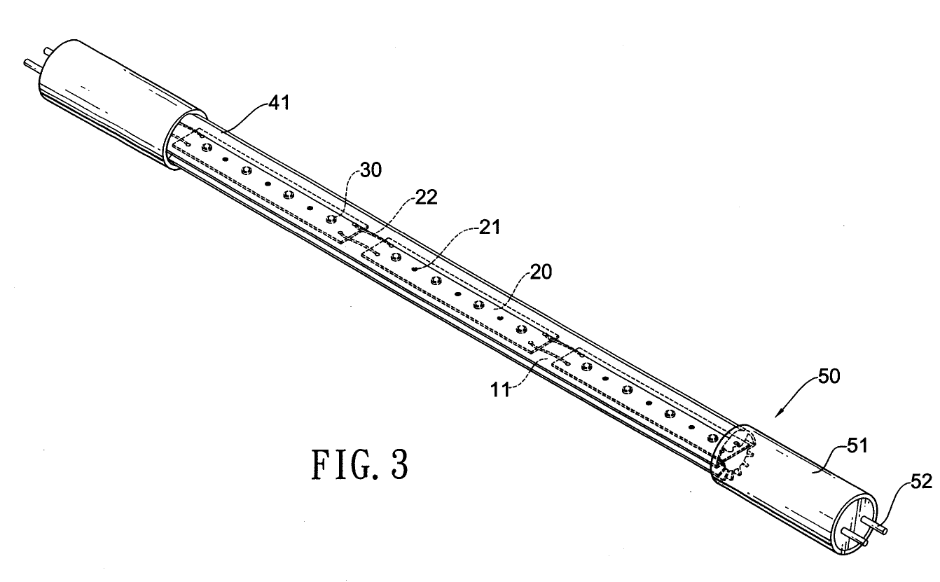

With further reference to FIG. 3, the electrical terminals (50) are respectively mounted on the ends of the seat (10) and are connected to the at least one board (21) through the wires (21) and each electrical terminal (50) has a casing (51) and two contacts (52). The casing (51) has a proximal end, a distal end and has a cavity (511). The cavity (511) is defined on the proximal end of the casing (51) and receives one end of the seat (10). The contacts (52) are mounted through the distal end of the electrical terminal (50) and connected to one of the at least one circuit board (30).

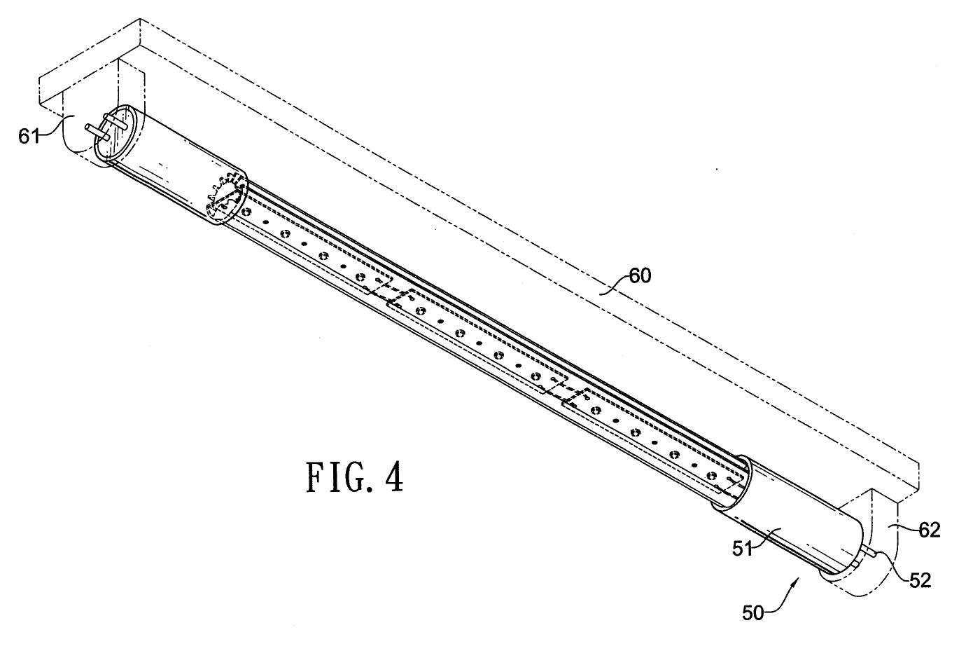

With further reference to FIG. 4, when the fluorescent tube is mounted on two sockets (61, 62) of a lamp holder (60), the LED (30) can emit the light. The light from the LEDs (30) passes through the lens (41) of the lampshade (40) and illuminate the indoor room so the fluorescent tube has more strength brightness. Because the fluorescent tube does not have a reflection board, the manufacturing time and cost of the fluorescent tube are decreased and the production rate of the fluorescent tube is increased.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fluorescent tube comprising
a seat having
a top;
a bottom;
two ends; and
a mounting surface being formed on the top of the seat;
at least one circuit board being mounted on the mounting surface and each one of the at least one circuit board having a top surface;
at least one set of light-emitting-diodes (LEDs) and each one of the at least one set being mounted on the top surface of one of the at least one circuit board;
a lampshade being transparent, being mounted on the seat, covering the at least one circuit board and having
an inner surface being opposite to the mounting surface of the seat; and
a lens being elongated, formed longitudinally on the inner surface and facing the LEDs; and
two electrical terminal being respectively mounted on the ends of the seat and connected to the at least one circuit board.

2. The fluorescent tube as claimed in claim 1, wherein each electrical terminal has
a casing having
a proximal end;
a distal end; and
a cavity being defined on the proximal end of the casing and receiving one end of the seat; and
two contacts being formed through the distal end of the electrical terminal and connected to one of the at least one circuit board.

3. The fluorescent tube as claimed in claim 1, wherein the seat is a heat sink and further has multiple fins being formed on and protruding radially from the bottom of the seat.

4. The fluorescent tube as claimed in claim 2, wherein the seat is a heat sink and further has multiple fins being formed on and protruding radially from the bottom of the seat.

5. The fluorescent tube as claimed in claim 1, wherein each one of at least one circuit board further has multiple fastening elements mounting the circuit board on the mounting surface.

6. The fluorescent tube as claimed in claim 2, wherein each one of at least one circuit board further has multiple fastening elements mounting the circuit board on the mounting surface.

7. The fluorescent tube as claimed in claim 3, wherein each one of at least one circuit board further has multiple fastening elements mounting the circuit board on the mounting surface.

8. The fluorescent tube as claimed in claim 4, wherein each one of at least one circuit board further has multiple fastening elements mounting the circuit board on the mounting surface.

9. The fluorescent tube as claimed in claim 5, wherein the fastening elements are screws.

10. The fluorescent tube as claimed in claim 6, wherein the fastening elements are screws.

11. The fluorescent tube as claimed in claim 7, wherein the fastening elements are screws.

12. The fluorescent tube as claimed in claim 8, wherein the fastening elements are screws.

13. The fluorescent tube as claimed in claim 1, wherein the fluorescent tube has multiple circuit boards and adjacent circuit boards are connected together through wires.
